(19) United States
(12) Patent Application Publication
(10) Pub. No.: US 2004/0070750 A1
(43) Pub. Date: Apr. 15, 2004

(54) Optical time domain reflectometry system and method

(76) Inventors: John M. Iannelli, San Marino, CA (US); Walter G. Soto, Irvine, CA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/267,760

(22) Filed: Oct. 9, 2002

(51) Int. Cl. G01N 21/00

(52) U.S. Cl. 356/73.1

(57) ABSTRACT

A system for testing a fiber comprises a light source, such as a laser, that transmits light pulses into the fiber while the fiber is not carrying payload data, and a monitor photo diode that measures reflections from the light pulses. A driver system for the laser, comprises a driver circuit that operates a laser for transmitting data, a pulse generator for causing the laser to generate a series of pulses, and a switch for selecting either the driver circuit or the pulse generator to control the laser.

### FIELD OF THE INVENTION

The present invention relates to optical fiber communications generally, and more specifically to optical time domain reflectometry (OTDR) systems and methods.

### BACKGROUND OF THE INVENTION

Recently, new optical access transceivers have incorporated real time monitoring and diagnostic functions for parameters within the optical transceiver. For example, these functions may include measuring internal module temperature, transmit or receive power supply rail, measured optical receive power, Loss of Signal (LOS), enable/disable controls and a state indicator. All of these new optical transceiver parameters are typically reported through a simple two-wire I²C bus so that an optical line card's maintenance software can report the status of its transceiver modules. No fiber related information was included.

The majority of capital expense associated with the use of fiber is not the optical transceiver cost but the expenses related to fiber access deployment. These deployment expenses may include provisioning, maintenance and administration of the fiber plant. This factor was considered in the decision to incorporate monitor and diagnostics of the optical transceivers within new optical transceivers. These capabilities give service providers the ability to detect problems within the transceiver itself. However the majority of the cost associated with fiber deployment does not come from the material expenses related to the optical transceivers themselves but the labor cost of “truck rolls” associated with provisioning, installation, maintenance and identifying link failures of the Fiber network. When deploying fiber links, the term “truck roll” is used to refer to the process of enabling reliable fiber links that take fiber test measurements after each splice or connector is added to the link.

Optical Time-Domain Reflectometry (OTDR) is a common method used to characterize point-to-point fiber links. Essentially, fiber optic test equipment shoots a short pulse of light down one end of the fiber and monitors light scattered back to the test instrument. Intrinsic scattering by atoms in the glass, an effect called Rayleigh scattering, produces a background signal similar to the way radar works. Irregularities such as splices, connectors and defects in the fiber reflect and scatter additional light back to the test instrument.

Fiber tests are expensive due to labor and special fiber interfaces required along with additional wavelengths reserved for specific fiber test measurements and equipment. Often the deployment and testing process takes weeks to achieve desired link integrity and still requires additional truck rolls to identify link failures after service is turned on. This fiber deployment and maintenance process is too inefficient and is limiting the growth of fiber-to-the-home and fiber-to-the-business markets.

Improved testing systems and methods are desired.

### SUMMARY OF THE INVENTION

A system for testing a fiber comprises a light source that transmits light pulses into the fiber while the fiber is not carrying payload data, and a monitor photo diode that measures reflections from the light pulses.

### BRIEF DESCRIPTION OF THE DRAWINGS

FIG. 1 is a block diagram of a system according to an exemplary embodiment of the invention.

FIG. 2 is a flow chart diagram of a method according to an exemplary embodiment of the invention.

FIG. 3 is a diagram showing reflected light amplitude versus distance from the laser.

### DETAILED DESCRIPTION

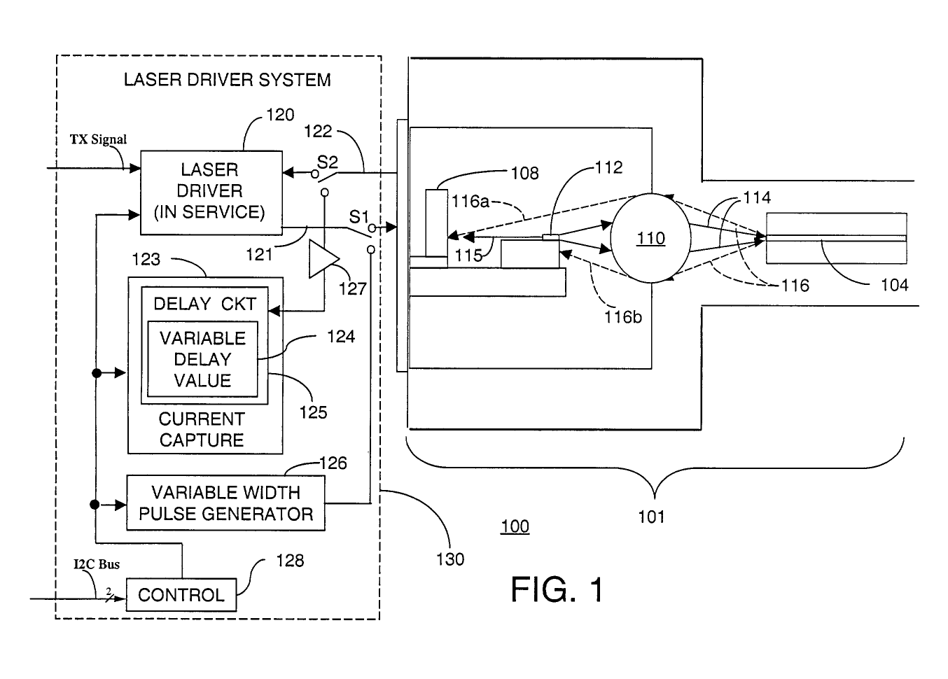

FIG. 1 is a block diagram of a system 100 for testing a fiber 104. The system 100 comprises a light source 112 that transmits light pulses 114 into the fiber 104 while the fiber is not carrying payload data, and a monitor photo diode 108 that measures reflections 116a from the light pulses. The exemplary light source 112 is included in a transmit optical sub-assembly (TOSA) 101.

In the exemplary TOSA 101, the light source is a laser 112. The laser 112 emits back facet light 115 when transmitting payload data. This back facet light 115 can be captured using an inexpensive, low-performance monitor photo diode (MPD) 108 that is used by dual loop control circuitry 120 in an external laser driver. The monitor photo diode 108 is used to measure back facet light 115 from the laser 112 to control the laser while the fiber 104 is “in service,” i.e., when the fiber is carrying payload data. The same monitor photo diode 108 can be used to measure reflections 116a while the fiber 104 is “out-of-service,” i.e., the fiber is not available for carrying payload data. The phrase “out-of-service,” is used herein for the time when the fiber is being tested by OTDR. The monitor photodiode 108 can provide an output current that is directly proportional to the power of the light that impinges on the photodiode.

The TOSA 101 of system 100 has a lens 110 between the laser 112 and the fiber 104. The lens 110 may be a ball lens, for example. The lens 110 focuses light into the fiber 104 while the fiber is in service. In preferred embodiments, the same lens 110 can also focus the reflected light 116a onto the monitor photodiode 108. Generally, the magnitude of the reflected light 116a is substantially less than the magnitude of the back facet light 115. To allow use of the same photodiode for measuring back facet light 115 and reflected light 116a, in some embodiments, the lens 110 is aligned so as to enhance the intensity of the reflections 116a that reach the monitor photodiode 108 relative to a lens alignment that maximizes transmission to the fiber 104. Preferably, this enhancement is achieved without substantially reducing transmitted light while the fiber is “in service,” i.e., while the fiber is carrying payload data.

In other embodiments, the lens 110 may be aligned to maximize the intensity of the reflections 116a that reach the monitor photodiode 108. Depending on how such an alignment affects the ability to focus the light into the fiber 104 during in-service operation, the alignment of the lens may be changed between an in-service alignment and an out-of-service OTDR alignment. If the lens 110 is to be re-aligned each time the device is taken out-of-service for OTDR and each time the device is placed back in-service for carrying payload data, then it is preferable for the in-service alignment to maximize light transmitted to the fiber 104, and out of service alignment to maximize reflected light on the monitor photodiode 108. Light 116b is shown to point out that not all of the reflected light 116 reaches the monitor photodiode 108. Some of the reflected light is absorbed at various points along the reflection path.

The system further comprises a laser driver circuit 120 that receives a transmit (TX) signal and controls the laser 112 to transmit light while carrying payload data. An example of a laser driver suitable for use in system 100 is the AGRCLD2G5 3.3 V 2.5 Gbit/sec. laser driver sold by Agere Systems, Inc. of Allentown, Pa.

A plurality of components are provided that are adapted for use during the “out-of-service” OTDR testing described below. These components provide a different set of inputs during OTDR testing, and receive the outputs of the testing.

A switching means (e.g., a circuit) is provided for bypassing the laser driver circuit 120 when transmitting the light pulses during “out-of-service” OTDR testing. This circuit may comprise a plurality of switches S1, S2. Alternatively, a multiplexer (not shown) may be used. Other types of switching means may also be used. The switching means may be manually actuated. Alternatively, the switching means may be controlled by the control block 128.

A pulse generator 126 causes the laser to 112 generate a series of pulses. The pulse generator 126 can be connected to the laser 112 by operating switch S1. Reflections from these pulses are measured during out-of-service OTDR testing. Pulse generator 126 is capable of varying at least one of the group consisting of a width of the pulses and an amplitude of the pulses. A preferred pulse generator 126 is capable of varying both pulse width and amplitude. In preferred embodiments, while measuring reflections from different points along the fiber 104, as the distance of the point (from the laser 112) increases, the width and amplitude of the pulse used to interrogate the fiber at that point are also increased.

Switch S2 provides the photodiode output signal 122 to either the in-service laser driver 120 while the laser 112 transmits payload data or to an amplifier 127 during “out-of-service” OTDR testing. Amplifier 127 amplifies the output of the monitor photodiode 108 in response to the reflections 116a before the output is measured, The amplifier 127 has a higher gain than is applied to back facet light 115 when the laser is carrying the payload data in service.

A current capture function 123 captures the monitor current measured by the monitor photodiode 108 during “out-of-service” OTDR. A delay circuit 125 has a variable delay value that is used to control when current from the photo diode 108 is measured, relative to a time when the light pulses are transmitted. A storage device 124 stores a plurality of delay values used to vary the delay. Each delay value corresponds to measurement of loss at a respective distance from the laser 112, and the delay circuit 125 sweeps a range of delays that corresponds to a length of the fiber 112.

A control function 128 is provided. The control function receives the state information from the I²C bus, controls the operation of the laser driver 120 during normal operation, and controls the current capture circuit 123 and pulse generator 126 during “out-of-service” OTDR operation. In some embodiments, the control function is a state machine implemented in application specific integrated circuits (ASIC). Other embodiments are also contemplated in which the control function can be performed under the control of software executed in a microprocessor.

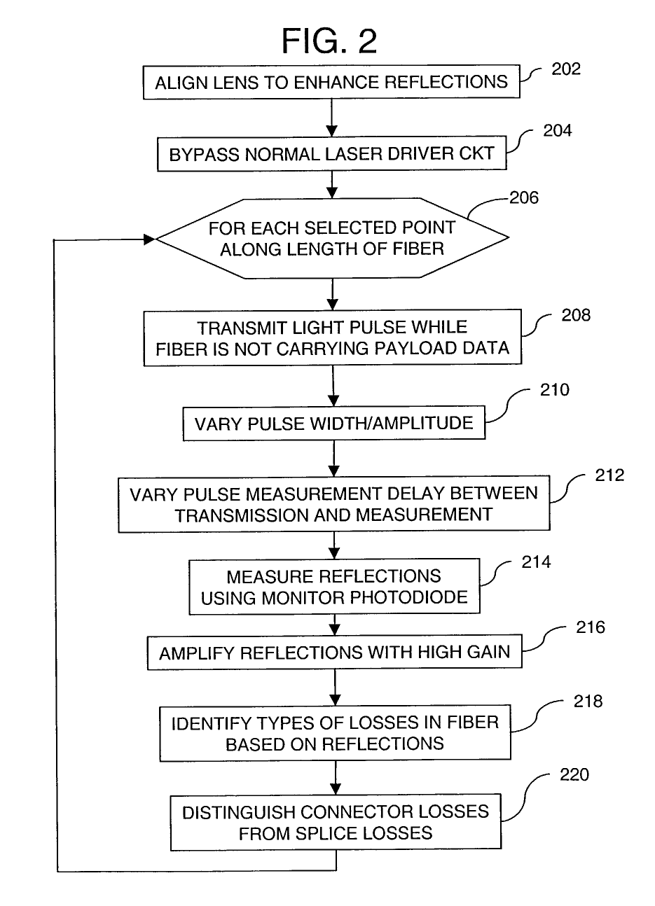

FIG. 2 is a flow chart diagram of an exemplary method for “out-of-service” OTDR testing. Although reference numerals are provided with respect to the apparatus shown in FIG. 1, the method steps described below may also be performed using other laser systems.

During “In-Service” or active payload data service times, current from the MPD 108 is typically used (but not required) by dual loop laser driver 120 to maintain consistent performance in laser 112 by continuously sensing the optical output and correcting variations that are typically caused by changes in operating temperature and/or laser diode degradation over time. Dual loop control of both laser diode average output power and extinction ratio is maintained. Due to the nature of laser diode construction, little (if any) light 116 reflected back from the fiber 104 goes through the laser diode 112 out the back facet side.

At step 202, a lens 110 is aligned between the laser 112 and the fiber 104, to enhance the intensity of the reflections that reach the monitor photodiode 108. Optionally, the aligning step may include aligning the lens 110 to maximize the reflections that reach the monitor photodiode 108.

Alternatively, or in addition to the alignment, the monitor photodiode 108 may be positioned at an optimal location for enhancing the impingement of reflected light 116a on the photodiode without substantially reducing the amount of back facet light that reaches the photodiode during “in-service” operation.

At step 204, the switching means (e.g., S1, S2 or a multiplexer, not shown) are switched to bypass the laser driver circuit 120 that is used to drive the laser to transmit the payload data. Before taking measurements, the system waits a period of time for any sort of parasitic effects or transitory response in the monitor photodiode 108 to settle out.

At step 206, a loop is performed for each point along the length of the fiber at which the reflected light is to be measured. For a long fiber, the loop may be repeated a thousand times or more.

At step 208, the variable width/amplitude pulse generator 126 transmits light pulses 114 into the fiber 104 while the fiber is not carrying payload data.

At step 210, the pulse width and/or amplitude is varied between each pair of successive pulses. Preferably, the width and amplitude of the pulse is increased as the distance between the laser 112 and the point at which the reflection is measured increases. Generally, as the distance from the laser increases, the reflection from a given point decreases if a fixed pulse amplitude and pulse width are used. By increasing the pulse width and pulse amplitude, the likelihood of detecting a more distant splice or connector is increased. In the exemplary embodiment, software drivers managing the I²C bus interface on SFP (Small Form-Factor Plugable) Optical Transceivers configure both the pulse width and MPD reflection measurement delay period. Further, the optimal pulse width for any given distance may vary from one photodiode to another.

At step 212, the pulse measurement delay between transmission and measurement is varied between each pair of successive pulses. A given pulse creates reflections all along the length of the fiber 104. The further the measured point is from the laser 112, the longer the delay before light reflected from that point reaches the monitor photodiode 108. The series of iterations sweeps a range of delays that corresponds to a length of the fiber 104.

At step 214, reflections 116a from the light pulses are measured using a monitor photo diode 108. Preferably, the same monitor photodiode 108 used to monitor the back facet light 115 from the laser 112 is also used to measure reflections during this step.

At step 216 the signals 122 representing the reflections 116a are amplified (e.g., in amplifier 127) before capture, using a higher gain than is applied to back facet light 115 when the back facet light is being measured.

At step 218 one or more types of loss in the fiber are identified, based on the reflections. For example, at step 220, connector losses can be distinguished from splice losses.

After step 220, the loop is repeated for each data point to be collected along the length of the fiber 104.

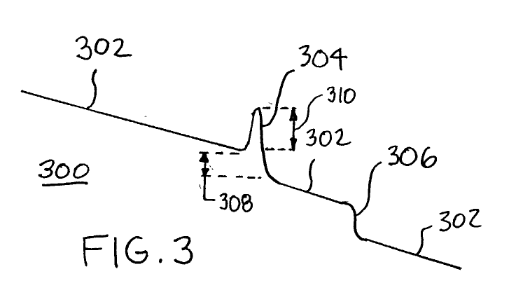

FIG. 3 is a diagram showing exemplary reflections that can be measured using the above described OTDR method. The signal trace 300 primarily comprises approximately straight sloped line segments 302. The slope of line segments 302 is a measure of the fiber attenuation. Peak 304 is a typical reflection artifact that indicates the presence of a connector in the fiber path. Connectors show both loss 308 and increased reflection 310. The loss 308 is shown by a drop in the straight line segment 302 to the right of the peak 304. The increased reflection 310 is shown by a local peak. Drop 306 is a typical reflection artifact that indicates the presence of a fiber splice. Fiber splices usually cause loss (a drop in the signal trace) but do not cause a reflective peak.

OTDR is implemented by measuring the backscatter reflection of the outside fiber plant generated by pulsing the laser diode creating fiber signature information such as that shown in FIG. 3. In an exemplary TOSA101, the pulse width may be as little as 5 meters (or 35 nanoseconds) or as much as 250 meters (or 2 microseconds) for long distance OTDRs. In a system 100 that operates within these exemplary parameters, the OTDR cannot distinguish any events close to (e.g., less than 5 meters from) the laser diode itself. This is mainly because of the monitor diode 108 requires a minimum time for its signal to decay, and become sensitive to low energy reflections. This exemplary “Out-of-Service” OTDR system 100 would primarily be used to find faults in longer fiber runs—especially when they are remote, buried or otherwise inaccessible. Any splices or connectors in the immediate vicinity (within 20 to 50 meters) of the laser 112 are within the same building, and are more easily accessible than any problem areas outside the building.

The system described above allows inexpensive detection of fiber defects and identification of the type of defects and the approximate position of the defects with about 50 to 100 meter accuracy. If a serious defect is identified, then more sensitive equipment can be used to pinpoint the location precisely, and a truck roll may be initiated to correct the problem. This approach reduces the number of truck rolls, and saves them for serious problems.

In alternative embodiments, a sensor with a shorter signal decay time (e.g., avalanche photodiode) may be used, so that it is possible to measure the intensity of the reflections closer to the laser 112. However, such a sensor is likely to be more costly than a monitor photodiode.

By enabling Service Provider's Software management facilities to perform Soft OTDR during “Out-of-Service” periods, a tremendous amount of service and maintenance expense is saved. Most notable are expenses associated with truck rolls and labor required after each splice or connector is added. Technicians can remotely login to the actual optical line card used during “Out-of-Service” (no payload data service) periods and determine the quality and integrity of the fiber link in minutes without specialized test equipment.

Also once the service is turned on and a failure occurs, through software operations and management personnel can identify the where the problem lies (Optical Line Card, Optical Transceiver or Fiber) and deploy the appropriate resources thus saving time and optimally assigning valuable resources.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method for testing a fiber, comprising the steps of:
(a) transmitting light pulses into the fiber while the fiber is not carrying payload data;
(b) measuring reflections from the light pulses using a monitor photo diode; and
(c) identifying one or more types of loss in the fiber, based on the reflections.

2. The method of claim 1, wherein step (a) includes bypassing a laser driver circuit that is used to drive a laser to transmit the payload data.

3. The method of claim 1, wherein step (b) includes varying a pulse measurement delay between transmission and measurement of the pulses.

4. The method of claim 3, wherein each delay value corresponds to measurement of loss at a respective distance from the laser, and step (b) includes sweeping a range of delays that corresponds to a length of the fiber.

5. The method of claim 1, wherein step (a) includes pulsing a laser and varying at least one of the group consisting of a width of the pulses and an amplitude of the pulses.

6. The method of claim 1, wherein:
the light pulses are transmitted by a laser that transmits light to carry the payload data; and
the same monitor photodiode is used to measure back facet light from the laser to control the laser when the laser is carrying the payload data.

7. The method of claim 6, further comprising amplifying the reflections before measurement, using a higher gain than is applied to back facet light when the back facet light is being measured.

8. The method of claim 1, wherein step (c) includes distinguishing connector losses from splice losses.

9. The method of claim 1, wherein the light is transmitted from a laser, the method further comprising aligning a lens between the laser and the fiber, to enhance the intensity of the reflections that reach the monitor photodiode relative to a lens alignment that maximizes transmission to the fiber.

10. The method of claim 1, wherein the light is transmitted from a laser, the method further comprising aligning a lens between the laser and the fiber, to maximize the intensity of the reflections that reach the monitor photodiode.

11. A system for testing a fiber, comprising:
a light source that transmits light pulses into the fiber while the fiber is not carrying payload data; and
a monitor photo diode that measures reflections from the light pulses.

12. The system of claim 11, further comprising a delay circuit that stores a variable delay value that is used to control when current from the photo diode is measured, relative to a time when the light pulses are transmitted.

13. The system of claim 12, wherein the light source is a laser, the system further comprising:
payload data path laser driver circuitry that controls the laser to transmit light while carrying payload data; and
a circuit for bypassing the payload data path laser driver circuitry when transmitting the light pulses.

14. The system of claim 12, wherein each delay value corresponds to measurement of loss at a respective distance from the laser, and the delay circuit sweeps a range of delays that corresponds to a length of the fiber.

15. The system of claim 11, further comprising a circuit that varies at least one of the group consisting of a width of the pulses and an amplitude of the pulses.

16. The system of claim 11, wherein:
the light pulses are transmitted by a laser that emits back facet light when transmitting payload data; and
the monitor diode that measures reflections is also used to measure back facet light from the laser to control the laser when the laser is carrying the payload data.

17. The system of claim 16, further comprising a circuit that captures a monitor current from the monitor photo diode.

18. The system of claim 16, further comprising an amplifier that amplifies the reflections before measurement, the amplifier having a higher gain than is applied to back facet light when the laser is carrying the payload data.

19. The system of claim 11, wherein the light source is a laser, the system further comprising a lens between the laser and the fiber, the lens being aligned to enhance the intensity of the reflections that reach the monitor photodiode relative to a lens alignment that maximizes transmission to the fiber.

20. The system of claim 11, wherein the light source is a laser, the system further comprising a lens between the laser and the fiber, the lens aligned to maximize the intensity of the reflections that reach the monitor photodiode.

21. A driver system for a laser, comprising:
a driver circuit that operates a laser for transmitting data;
a pulse generator for causing the laser to generate a series of pulses; and
a switch for selecting either the driver circuit or the pulse generator to control the laser.

22. The driver system of claim 21, further comprising a circuit that varies a delay between transmission of one of the pulses and measurement of a reflected light from that pulse.

23. The driver system of claim 21, further comprising a storage device that stores a plurality of delay values used to control timing of measurement of a reflected light from respective pulses.

24. The driver system of claim 21, further comprising a circuit that captures a current measurement from a monitor photodiode that measures reflections from the pulses.

25. The driver system of claim 24, wherein the monitor photodiode is also used to measure back facet light from the laser.

26. The driver system of claim 21, wherein the pulse generator is capable of varying at least one of the group consisting of a width of the pulses and an amplitude of the pulses.
